(19) United States
(12) Patent Application Publication
(10) Pub. No.: US 2009/0327076 A1
(43) Pub. Date: Dec. 31, 2009

(54) AD TARGETING BASED ON USER BEHAVIOR

(75) Inventors: ALEKSEY SINYAGIN, BOTHELL, WA (US); RISHI BAL, BELLEVUE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/163,622

(22) Filed: Jun. 27, 2008

(51) Int. Cl. G06Q 30/00

(52) U.S. Cl. 705/14.53

(57) ABSTRACT

In accordance with embodiments of the present invention, systems and methods for providing customized advertising content are provided. When a user is browsing a webpage, client script code embedded in the webpage monitors the user's mouse and keyboard activity, for example, the time it takes the user to click on a link, the time between clicks, etc. This data may then be compiled and sent to an ad server, which responds in real time by placing advertisements suitable to the user at that moment. By comparing the user's activity data to known behavioral data, one can estimate or predict the identity of the user and the user's state of mind, and deliver the advertisements accordingly. As more data is collected, the ad server may act dynamically to present more advertisements.

### BACKGROUND

Advertising on the internet has distinct advantages over other types of advertising, particularly the ability to target users. By providing targeted advertisements to users, an advertiser may reach certain types of users that may have a higher probability of purchasing the advertiser's product. A user may be classified by age, sex, education level, gender, etc. For example, a person over the age of sixty will most likely not be interested in the same products as someone under twenty. Thus, targeting users allows advertisers to be more efficient with their advertising budgets, and only reach out to those demographics of specific interest to them.

Typically, the identity or behaviors of a user are estimated by various methods, such as keeping track of sites the user has visited, the ads viewed, geographical location of the user, and the like. For example, if a webpage publisher knows that a specific user has clicked on an advertisement in the past, it may use that knowledge in presenting future advertisements to the user. Employing such a method, however, requires that prior user information be known and the data be made available to the advertiser.

### SUMMARY

In accordance with embodiments of the present invention, systems and methods for providing customized advertising content are provided. When a user is browsing a webpage, client script code embedded in the webpage monitors the user's mouse and keyboard activity, for example, the time it takes the user to click on a link, the time between clicks, etc. This data may then be compiled and sent to an ad server, which responds in real time by placing advertisements suitable to the user at that moment. By comparing the user's activity data to known behavioral data, one can estimate or predict the identity of the user and the user's state of mind, and deliver the advertisements accordingly. As more data is collected, the ad server may act dynamically to present more accurately targeted advertisements.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of a computing system environment suitable for use in implementing embodiments of the present invention;

FIG. 2 is a block diagram illustrating an overview of a system in accordance with an embodiment of the invention;

FIG. 3 is a diagram illustrating a system for providing targeted advertising content, in accordance with an embodiment of the invention;

FIG. 4 is a flow diagram illustrating a method in accordance with an embodiment of the invention; and

FIG. 5 is a flow diagram illustrating a method in accordance with another embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In accordance with embodiments of the present invention, systems and methods for providing customized advertising content are provided. When a user is browsing a webpage, client script code embedded in the webpage monitors the user's mouse and keyboard activity, for example, the time it takes the user to click on a link, the time between clicks, etc. This data may then be compiled and sent to an ad server, which responds in real time by placing advertisements suitable to the user at that moment. By comparing the user's activity data to known behavioral data, one can estimate or predict the identity of the user and the user's state of mind, and deliver the advertisements accordingly. As more data is collected, the ad server may act dynamically to present more accurate targeted advertisements.

In accordance with one embodiment of the present invention, one or more computer storage medium with computer-executable instructions embodied thereon for performing a method for providing targeted advertising to a user based on the behavior of the user, the method comprising, in part, providing a webpage of a content owner, wherein the webpage includes a script code capable of monitoring a user's mouse and keyboard activity, compiling the activity data, and sending the compiled data to a server; receiving the user's activity data from the code; and dynamically providing advertisements for presentation on the webpage based on the activity data.

In another embodiment of the present invention, a computer system for providing targeted advertising to a user based on the behavior of the user while browsing a webpage, wherein the webpage is embedded with a script code capable of monitoring the user's activity, is provided. The computer system comprising, in part, a monitoring component configured to monitor the user's mouse and keyboard activity data; a compiling component configured to compile the activity data; a delivering component configured to deliver the compiled activity data to a server; and a presenting component configured to present targeted advertisements received from the server.

In yet another embodiment in accordance with the present invention, one or more computer storage medium with computer-executable instructions embodied thereon for performing a method for presenting targeted advertising to a user based on the user's behavior, the method comprising, in part, presenting a webpage to a user; monitoring the user's mouse and keyboard activity data; compiling the activity data; delivering compiled activity data to an ad server; receiving one or more targeted advertisements from the ad server; and presenting the one or more targeted advertisements on the webpage to the user.

Having briefly described an overview of embodiments of the present invention, an exemplary operating environment suitable for use in implementing embodiments of the present invention is described below.

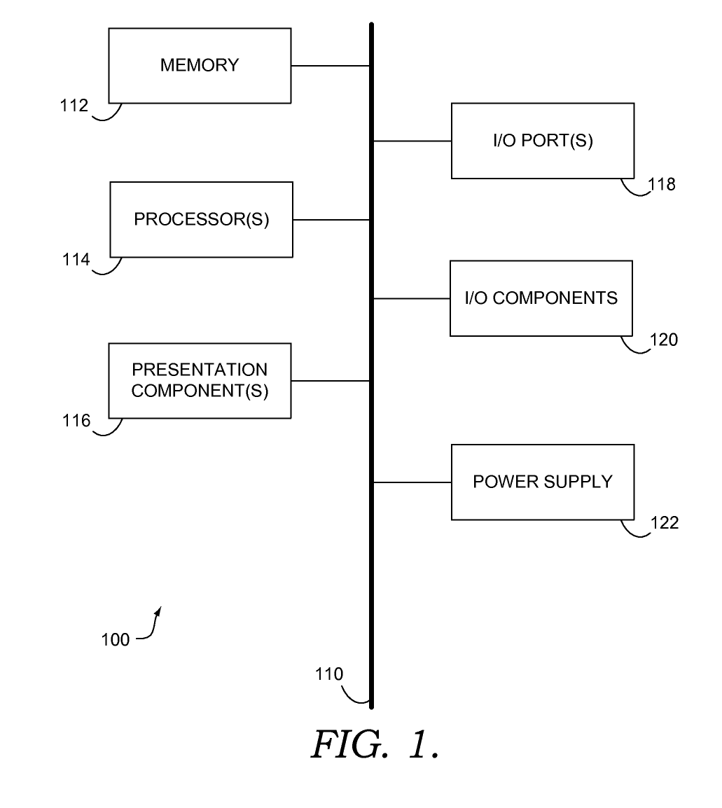

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-usable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

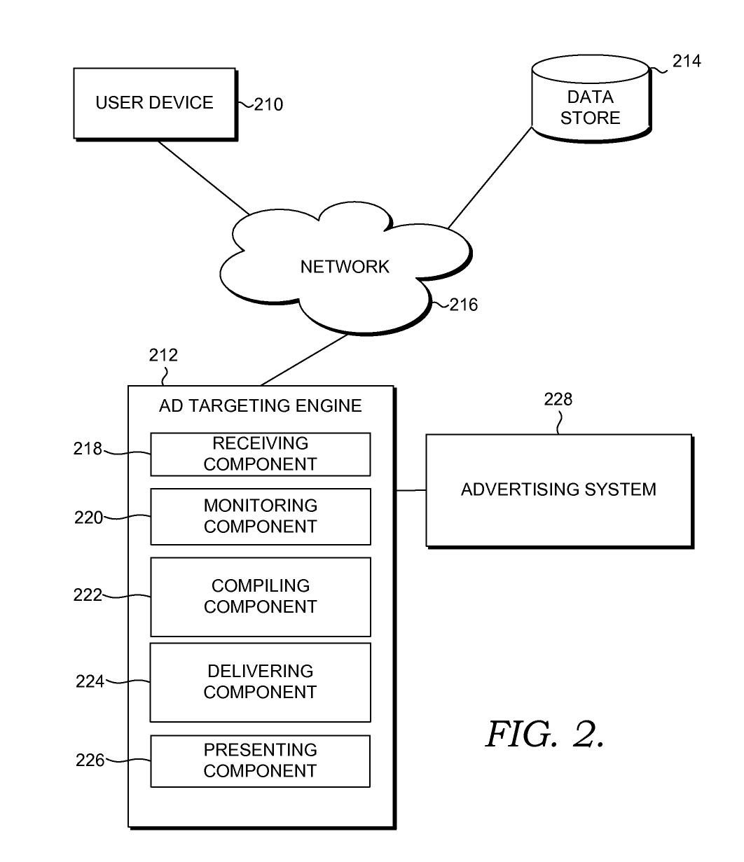

Turning now to FIG. 2, a block diagram is illustrated that shows an exemplary computing system 200 configured to provide targeted advertising content, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated therein.

Computing system 200 includes an ad targeting engine 212, a user device 210, and a data store 214 all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 may be configured to store information associated with various types of content, as more fully described below. It will be understood and appreciated by those of ordinary skill in the art that the information stored in the data store 214 may be configurable and may include any information relevant to online content. Further, though illustrated as a single, independent component, data store 214 may, in fact, be a plurality of data stores, for instance, a database cluster, portions of which may reside on a computing device associated with the ad targeting engine 212, the user device 210, another external computing device (not shown), and/or any combination thereof.

Each of the ad targeting engine 212 and the user device 210 shown in FIG. 2 may be any type of computing device, such as, for example, computing device 100 described above with reference to FIG. 1. By way of example only and not limitation, the ad targeting engine 212 and/or the user device 210 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of the embodiments hereof.

As shown in FIG. 2, the ad targeting engine 212 includes a receiving component 218, a monitoring component 220, a compiling component 222, a delivering component 224, and a presenting component 226. In some embodiments, one or more of the illustrated components 218, 220, 222, 224, and 226 may be implemented as stand-alone applications. In other embodiments, one or more of the illustrated components 218, 220, 222, 224, and 226 may be integrated directly into the operating system of the ad targeting engine 212 or the user device 210. In the instance of multiple servers, embodiments of the present invention contemplate providing a load balancer to federate incoming queries to the servers. It will be understood by those of ordinary skill in the art that the components 218, 220, 222, 224, and 226 illustrated in FIG. 2 are exemplary in nature and in number and should not be construed as limiting. Any number of components may be employed to achieve the desired functionality within the scope of the embodiments of the present invention. In some embodiments, the ad targeting engine 212 further includes an advertising system 228. The advertising system 228, as the other illustrated components of the ad targeting engine 212, may be implemented as a stand-alone application or may be integrated directly into the operating system of the ad targeting engine 212.

The receiving component 218 is configured for receiving content associated with targeted advertising and associated with data related to a user's activity. More specifically, the data related to a user's activity may include data related to the user's keyboard and mouse activity, as will be further described below. The targeted advertising content and user activity content may be received from various data sources. More specifically, targeted advertising content may be received from an advertising database, such as an advertising system. Once received by the receiving component 218, the content may be stored, for instance, in association with data store 214, such that it is searchable to determine satisfaction of a user query, as more fully described below. Such received content may additionally be indexed, if desired.

The monitoring component 220 is configured for monitoring a user's activity, such as activity of the user's mouse and keyboard while on the publisher's webpage. An exemplary method of monitoring a user's activity is by embedding a client script code into the publisher's webpage. Exemplary types of activities may be monitored, and one skilled in the art will appreciate that the type of activity or activities monitored may vary as necessary. By way of example, without limitation, monitored activities include the browsing time of the user, the number of clicks per minute, the time the mouse key was held down, the number of keyword clicks per minute, the time any keyboard key was pressed, the distance the mousepoint has moved between two clicks, time it takes the user to click on a link, the time between two clicks on the keyboard, etc.

After the monitored data has been compiled, it may then be analyzed using known behavioral data to estimate the identity of the user, and use this estimated identity to present specific, targeted ads to the user. Besides the physical state of the user, the mental or psychological state of the user may be estimated. As will be discussed further below, if the mental state of the user is understood, ads more closely targeted to the user may be presented and/or the appearance of the advertisement may be altered in accordance with the mental state of the user.

Such behavioral data, as would be appreciated by one skilled in the art, is not specific to the invention. In an embodiment in accordance with the present invention, In generating an image, one skilled in the art will appreciate that many aspects of the image may be created or modified. For example, the publisher may determine the outline, background, pattern, font, effect, transitions, etc. of the advertisement. The compiling component 222 is configured to compile the data that has been monitored.

The delivering component 224 is configured for delivering activity data to a server, such as a file server that provides the advertising content, and also for delivering targeted advertising content to, for example, the webpage being viewed by the user. In embodiments of the present invention, a script code is included on the webpage, and the user's activity is monitored and stored in an associated array. Such stored activity may then be delivered to a server that will use the activity to determine which advertisement(s) would best target the user.

The presenting component 226 is configured for presenting at least one targeted advertising unit based on the user's activity. Typically such presentation will be by way of display in associations with a user interface. However, other forms of presentation, including audio presentation and audio/video presentation, are contemplated to be within the scope of embodiments hereof.

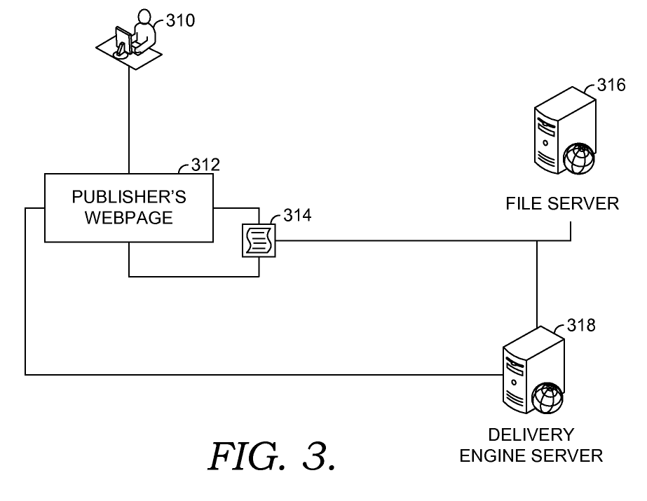

FIG. 3 illustrates an exemplary system 300 for providing targeted advertising. As shown in FIG. 3, a user, such as user 310, visits the publisher's webpage, as shown at 312. The file server 316 that is providing the advertisements to the webpage adds a targeting script and a client side script, such as javascript, to the publisher's webpage. Once the user begins browsing the webpage 312, the user's behavior is monitored and stored in the script array, shown at 314. In embodiments, the client side script on the webpage attaches itself to an inbuilt timer, which enables the user's behavior to be monitored. The user's behavior may be monitored, whether the user is active or sedentary.

Initially, the advertisements provided to the webpage by the file server 316 are loaded from the delivery engine server 318. If prior data exists associated with the user, this data may be attached to the delivery engine request and used to provide ads to the user. As data related to the user's activity is collected in the array, it is sent in real time back to the servers. Thus, the process of delivering targeted ads can dynamically adjust, for example, if the behavior of the user changes.

Known behavioral data (e.g., from Luscher tests, etc.) are well known in the art, and will be not fully described herein. One skilled in the art will appreciate that any such data may be used in conjunction with this invention.

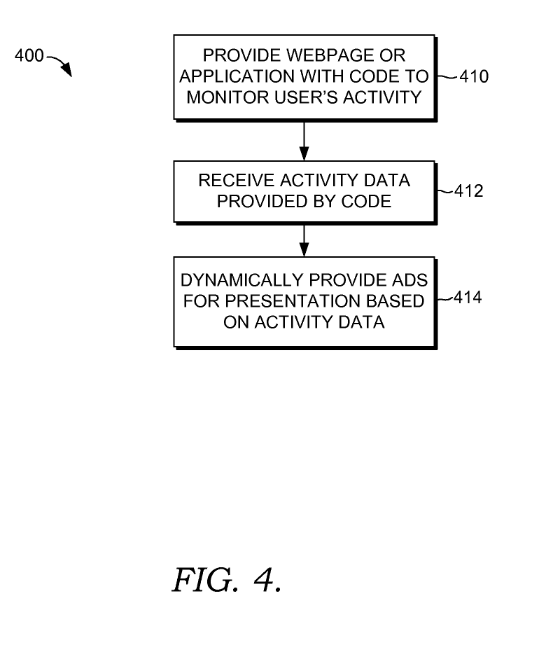

Turning now to FIG. 4, an illustrative method for providing targeted advertising to a user based on the behavior of the user is provided. Initially, as indicated at block 410, a webpage or other application is provided to a user, where the webpage or application corresponds to a publisher or content owner. The application is embedded with a script code on the client side, such as a java script, that has, for example, been received from an ad server. The script code then monitors the user's activity, as indicated at block 412. Activity to be monitored includes mouse and keyword activity and the like. Next, at block 414, the ad server provides targeted advertisements to the application, using the activity data provided in the previous step.

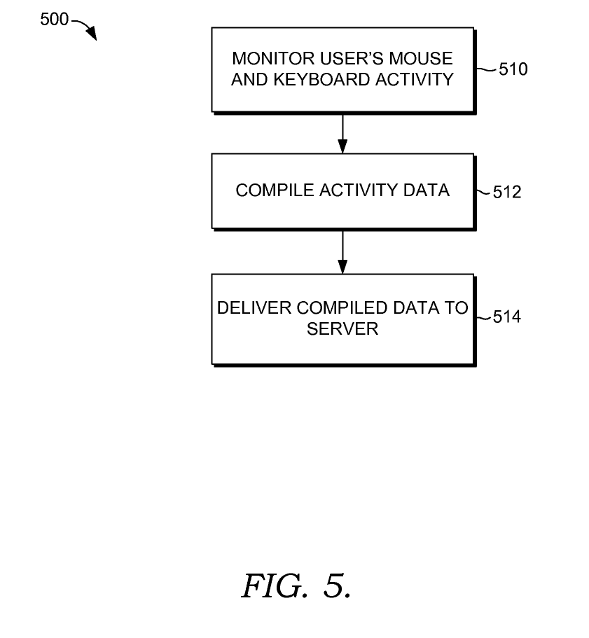

Turning now to FIG. 5, an illustrative method for providing targeted advertising to a user based on the behavior of the user is provided. Initially, as indicated at block 510, a user's mouse and keyboard activity is monitored (e.g., utilizing the monitoring component 220 in FIG. 2). Then, the activity data is compiled (e.g., utilizing the compiling component 222 in FIG. 2) in order to send the activity data to the ad server using the embedded script code. This is indicated at block 514.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer storage medium with computer-executable instructions embodied thereon for performing a method for providing targeted advertising to a user based on the behavior of the user, the method comprising:
providing an application of a content owner, wherein the application includes a script code capable of monitoring a user's mouse and keyboard activity, compiling the activity data, and sending the compiled data to a server;
receiving the user's activity data from the code; and
dynamically providing advertisements for presentation on the application based on the activity data.

2. The one or more computer storage medium of claim 1, wherein the server is an ad server.

3. The one or more computer storage medium of claim 2, wherein the script code is provided to the publisher by the ad server.

4. The one or more computer storage medium of claim 1, wherein dynamically providing advertisements comprises analyzing the correlation between the activity data and known behavioral data.

5. The one or more computer storage medium of claim 4, wherein dynamically providing advertisements further comprises determining an estimate of the user's age based on the correlation between the activity data and the known behavioral data.

6. The one or more computer storage medium of claim 4, wherein dynamically providing advertisements further comprises determining an estimate of the user's gender based on the correlation between the activity data and the known behavioral data.

7. The one or more computer storage medium of claim 4, wherein dynamically providing advertisements further comprises determining an estimate of the user's mental state based on the correlation between the activity data and the known behavioral data.

8. A computer system for providing targeted advertising to a user based on the behavior of the user while browsing a webpage, wherein the webpage is embedded with a script code capable of monitoring the user's activity, the computer system comprising:
a monitoring component configured to monitor the user's mouse and keyboard activity data;
a compiling component configured to compile the activity data;
a delivering component configured to deliver the compiled activity data to a server; and
a presenting component configured to present targeted advertisements received from the server.

9. The computer system of claim 8, further comprising an advertising system.

10. The computer system of claim 8, wherein the server is an ad server.

11. The computer system of claim 10, wherein the script code is provided to the publisher by the ad server.

12. The computer system of claim 8, wherein the presenting component dynamically provides advertisements to the webpage by analyzing the correlation between the activity data and known behavioral data.

13. The computer system of claim 12, wherein the presenting component dynamically provides advertisements to the webpage by further determining an estimate of the user's age based on the correlation between the activity data and the known behavioral data.

14. The computer system of claim 12, wherein the presenting component dynamically provides advertisements to the webpage by further determining an estimate of the user's gender based on the correlation between the activity data and the known behavioral data.

15. One or more computer storage medium with computer-executable instructions embodied thereon for performing a method for presenting targeted advertising to a user based on the user's behavior, the method comprising:
presenting a webpage to a user;
monitoring the user's mouse and keyboard activity data;
compiling the activity data;
delivering compiled activity data to an ad server;
receiving one or more targeted advertisements from the ad server; and
presenting the one or more targeted advertisements on the webpage to the user.

16. The one or more computer storage medium of claim 15, wherein the mouse and keyboard activity monitored comprises the time it takes the user to click the mouse.

17. The one or more computer storage medium of claim 15, wherein the mouse and keyboard activity monitored comprises the number of keyword clicks per minute.

18. The one or more computer storage medium of claim 15, wherein the mouse and keyboard activity monitored comprises the amount of time that the user presses a keyboard key.

19. The one or more computer storage medium of claim 15, wherein the mouse and keyboard activity monitored comprises the average time between mouse clicks.

20. The one or more computer storage medium of claim 15, wherein the mouse and keyboard activity monitored comprises the average time between keyboard clicks.
